(19) United States
(12) Patent Application Publication
(10) Pub. No.: US 2010/0332998 A1
(43) Pub. Date: Dec. 30, 2010

(54) COLLABORATIVE DOCUMENT ENVIRONMENTS IN THREE-DIMENSIONAL VIRTUAL WORLDS

(75) Inventors: Tong Sun, Penfield, NY (US); Jonas Karlsson, Rochester, NY (US); Wei Peng, Webster, NY (US)

Correspondence Address: Hoffmann & Baron, LLP, 6900 Jericho Turnpike, Syosset, NY, 11791, US

(73) Assignee: XEROX CORPORATION, Norwalk, CT (US)

(21) Appl. No.: 12/492,533

(22) Filed: Jun. 26, 2009

(51) Int. Cl. G06F 3/048

(52) U.S. Cl. 715/757

(57) ABSTRACT

Embodiments described herein are directed to a collaborative document environment for reviewing a collection of documents stored in a repository of a document management system. A shared collaborative document area in a virtual world is associated with a corresponding collection of documents in a document management system. The shared collaborative document area is customized based on a semantic context of the documents in the collection of documents.

### BACKGROUND

1. Technical Field

The presently disclosed embodiments are directed to a collaborative document environment in a three-dimensional virtual environment.

2. Brief Discussion of Related Art

Documents, as states of knowledge, play a significant role in enterprise collaboration. Traditional document management systems primarily support an individual user interacting with a collection of documents, such as content authoring, navigation/browsing, access control, tagging, versioning, etc. In the past several years, there has been a strong trend to embrace collaborative Web 2.0 technologies (e.g. wiki, blogs, social community, instant messaging (IM), voice over IP, video streaming) in document management systems to support some sort of synchronous or asynchronous collaboration in virtual workspaces.

However, these web 2.0 enabled collaborations are primarily centered on the evolution of the content (i.e. text, image, video, audio), and typically neglect some important aspects of human interaction (e.g. social and/or visual cues). For instance, remote participants in web conferencing or online learning may not be fully immersed in the experience and as a result, the participants can feel less engaged or less productive than if the participants were together in a conference room or a lecture hall. Furthermore, there is typically little support for direct social interactions among participants in existing document management systems, beyond instant messaging or voice communication. Although telepresence and video conferencing technologies are evolving rapidly, they typically do not fully address collaborations around content repositories or document content.

### SUMMARY

According to aspects illustrated herein, there is provided a method for reviewing a collection of documents stored in a repository of a document management system. The method includes associating a shared collaborative document area in a three-dimensional (3D) virtual world with a corresponding collection of documents in a document management system. The method also includes customizing the shared collaborative document area based on a semantic context of the documents in the collection of documents.

According to further aspects illustrated herein, there is provided a computer readable medium storing instructions executable by a computing system including at least one computing device, wherein execution of the instructions implements a method for reviewing a collection of documents stored in a repository of a document management system. Execution of the instructions implement a method that includes associating a shared collaborative document area in a three-dimensional (3D) virtual world with a corresponding collection of documents in a document management system and customizing the shared collaborative document area based on a semantic context of the documents in the collection of documents.

According to other aspects illustrated herein, there is provided a system for reviewing a collection of documents stored in a repository of a document management system. The system includes a computer system having one or more computing devices. The computing system is configured to associate a shared collaborative document area in a three-dimensional (3D) virtual world with a corresponding collection of documents in a document management system. The computer system is also configured to customize the shared collaborative document area based on a semantic context of the documents in the collection of documents.

### BRIEF DESCRIPTION OF THE DRAWINGS

FIG. 1 is a block diagram illustrating an exemplary collaborative document environment.

FIG. 2 is an exemplary computing system configured to implement embodiments of the collaborative document environment.

FIG. 3 is a block diagram of an exemplary computing device configured to implement embodiments of an interfacing unit and/or an interaction management system.

FIG. 4 illustrates an exemplary implementation of teleporting from a document system to a collaborative document environment.

FIG. 5 illustrates an exemplary implementation of teleporting from a first location in a 3D virtual world to a collaborative document environment.

FIGS. 6-10 illustrate various implementations of a collaborative document area in a 3D virtual world.

FIGS. 11 and 12 illustrate exemplary navigation through documents stored in a content repository using the collaborative document environment.

FIG. 13 illustrates an exemplary organization of documents in a collaborative document area.

FIG. 14 is a flowchart illustrating an exemplary implementation of a collaborative document area.

FIG. 15 is a flowchart illustrating an exemplary implementation of teleporting users to a collaborative document area and maintaining access control to documents in the collaborative document area.

### DETAILED DESCRIPTION

Exemplary embodiments include a collaborative document environment to facilitate a shared three-dimensional (3D) virtual space for integrating content of documents with collaborative interactions of a community of avatars. The collaborative document environment interfaces a document management system with a shared 3D virtual world to facilitate user interaction with documents in the document management system independently and/or as part of a community in which other users can collaborate with the user at the same time. The collaborative document environment can automatically teleport a collection of documents from a content repository of the document management system to an instantiated shared collaborative document area in the 3D virtual world. The collaborative document environment can be customized based on semantic context of the documents and user specified preferences. Exemplary embodiments of the collaborative document environment facilitate content-driven collaborations with an engaging, immersive, social, and efficient user experience.

As used herein, a “document management system” refers to a system for managing document storage, retrieval, modification, and the like. A document management system can include “content repository” and one or more software applications for interfacing with the content repository, where a content repository is a storage device in which documents are stored.

As used herein, a “document” refers to computer file that contains information. Some examples of documents include word processing files, portable document files (PDFs), spreadsheet files, image files, video files, sound files, 3D model files, slide presentation files, and the like.

As used herein, an “identifier” refers to a string of characters, where a “collection identifier” uniquely identifies the collection of documents in a particular content repository and a “virtual identifier” uniquely identifies an area in a particular 3D virtual world.

As used herein, a “collaborative document area” refers to a shared virtual 3D space in a 3D virtual world, in which user represented as avatars can interact with each other as well as with documents contained in the collaborative document area.

As used herein, a “3D virtual world” refers to a computer simulated 3D environment in which users, represented as avatars, can interact.

As used herein, an “avatar” refers to a computer animation of the user in a 3D virtual world.

As used herein, “customizing” refers arranging, organizing, and/or configuring a collaborative document area in accordance with specification defined by a user and/or by a software application implemented by a computing device. Customizing can include defining a 3D scene and a spatial layout, where a “3D scene” refers to a themed representation of an area and a “spatial layout” refers to an arrangement and/or organization of documents in the collaborative document area.

As used herein, “semantic context” refers to a purpose, intention, function, and the like of the document based on a meaning of information contained in the documents and/or meta-data properties of the documents, where “meta-data properties” refer to information about the documents, such as, for example, a title, summary, description, creator/owner, timestamp, file type, date of creation, and the like. Some examples of semantic contexts include presentations, lectures/class, projects, exhibits, and the like

As used herein, a “virtual pass” refers to an access level associated with a user and is used to determine whether a user can access a collaborative document area having a specified security level, where a “security level” refers to an access control mechanism for restricting access to user who have a proper virtual pass.

As used herein, ‘transporting” and “teleporting” are used interchangeably and refer to moving, copying, or mapping an object or item, such as an avatar or documents from a first location, such as a first location in 3D world or a document management system, to a second location, such as a collaborative document area.

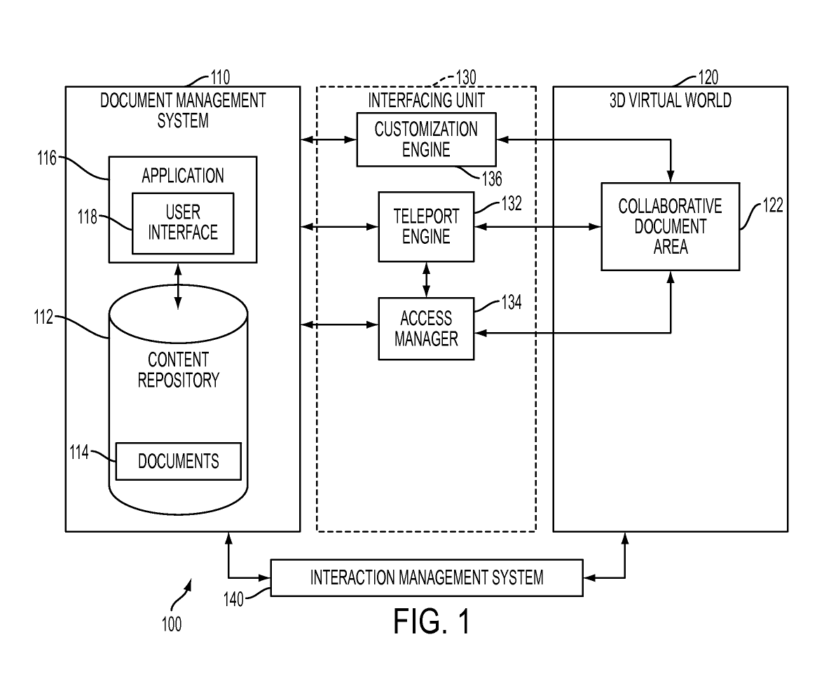

FIG. 1 is a block diagram illustrating an exemplary collaborative document environment 100 (hereinafter “environment 100”) that includes a document management system 110, a three-dimensional (3D) virtual world environment 120 (hereinafter “3D virtual world 120”), an interfacing unit 130, and an interaction management system 140. The environment 100 can enhance a document review experience and allows users interact with documents as well as to collaborate with other users in an immersive, engaging, and social virtual environment. The environment 100 can be implemented to provide, for example, delivery media for existing document services (e.g. online conferencing/training/learning service, remote help-desk or field service), virtual document services (e.g. collaborative document search, collaborative document tagging), and the like.

The document management system 110 includes a content repository 112 that stores documents 114 and implements at least one software application 116 executed using a computing device to provide a user interface 118 to facilitate interaction between a user and the content repository 112. The document management system 110 can control the organization, storage, retrieval, security, and integrity of documents 114 in the content repository 112. Some examples of software applications that can be enhanced to for implement at least portions of document management systems include Sharepoint® from Microsoft Corporation, DocuShare® from Xerox Corporation, LotusNotes® from International Business Machines (IBM) Corporation, and the like.

The content repository 112 stores collections of documents 114, which can be accessed by users via the user interface 118 of the application 116. The collection of documents can be identified using a collection identifier. In some embodiments, the collection identifier can be a uniform resource identifier (URI), such as a uniform resource locator (URL) address. The collection of documents 114 in the content repository 112 can be structured to organize the documents 114 in predefined manner. The document management system 110 can enforce a logical structure of the content repository 112 and can allow one or more users to store, access, retrieve, modify, and the like, documents 114 in the content repository 112. For example, the content repository 112 can use a relational model, a hierarchical model, a network model, an object-oriented database model, an extensible mark-up language (XML) based database model, and/or the like, the implementation of which are well known to those skilled in the art.

The content repository 112 can include meta-data properties to associate information about the documents with the documents in the content repository 112. Meta-data properties can include a title of a document, summary of a document, description of a document, file type of a document, date of creation of a document, identity of the creator of a document, and the like. The meta-data properties can be extended to include information corresponding to document interactions. The meta-data can facilitate searching or navigating of the content repository 112 and/or can be used to customize a corresponding collaborative document area.

The user interface 118 can include a graphical user interface, a command line interface, or other user interfaces to allow a user to access, search, retrieve, modify, organize, and the like, documents in the content repository 112. Access to the documents 114 in the content repository can be predicated on user authorization such that once an identification of the user has been established by logging in, the user can access all, some, or none of the documents 114. The user interface 118 can include a teleport button, the activation of which can initiate a transfer of the user and a collection of documents 114 currently accessed by the user to a collaborative document area 122 in the 3D virtual world 120.

The document management system 110 can implement a security policy to restrict access of documents within the content repository 112. For example, access to the documents in the content repository 112 can require users to login in to the document management system 110 using a username and password. The security policy can assign security levels to some, all, or none of the documents 114 in the content repository 112 such that only user meeting the specified security levels can access the documents 114.

The 3D virtual world 120 includes the collaborative document area 122 and is a computer simulated environment in which users, represented as avatars, can interact. Users of the 3D virtual world can experience a telepresence, which allows the user to feel as if they are actual present in the 3D virtual world 120 and/or that they have a physical effect at a location other than their true physical location. Avatars representing users can facilitate a broad range of communications such as text, graphics, visual gestures, social cues, sounds, animations, and the like. Areas in the 3D virtual world 120 can appear similar to the real world and/or can depict fantasy worlds. Rules can be applied in the 3D virtual world 120 to model real world attributes, such as gravity, topography, locomotion, real-time actions, and communication. Some examples of 3D virtual worlds can include Second Life from Linden Research, Inc. (Linden Labs®), Project Wonderland from Sun Microsystems, Inc., Qwaq Forums from Qwaq, Inc, and the like.

The collaborative document area 122 can be generated in the 3D virtual world 120 and can be associated with the content repository 112, a group of documents 114 in the content repository 112, multiple content repositories, a group of documents 114 that are distributed among multiple content repositories, and the like. The location of the collaborative document area 122 can be identified using a virtual identifier. The virtual identifier can be assigned by the virtual world 120 or can be generated by the creator of the collaborative document area 122. For example, when the virtual world is implemented using Second Life, the unique virtual identifier can be a Second Life Uniform Resource Locator (SLURL) address. Avatars representing users can be teleported to the collaborative document area 122 upon entering the identifier corresponding to the collaborative document area 122 or can be teleported using a collection identifier that identifies the underlying collection of documents in the content repository.

The interfacing unit 130 includes a teleport engine 132, an access manager 134, and a customization engine 136. The interfacing unit 130 allows user to transition between the user interface 118 of the document management system 110 and the collaborative document area 122 in the 3D virtual world 120 and/or between a first location in the 3D virtual world 120 and the collaborative document area 122 in the 3D virtual world 120. The interface unit 130 can be implemented in a distributed manner where one or more components of the interface unit 130 are implemented using different computing devices or can be implemented in an integrated manner in which the components of the interface unit 130 are implemented using a single computing device.

The teleport engine 132 can transport a user to the collaborative document area 122 corresponding to a collection of documents 114 that are stored by the data management system 110. The teleport engine 132 manages a one-to-one (1:1) mapping from a collection of documents 114 in the content repository 112 to the corresponding collaborative document area 122 in the 3D virtual world 120. The 1:1 mapping associates the collection of documents with the collaborative document area to ensure that each document in the collection of documents 114 is available for review in the collaborative document area 122. The mapping can occur between a repository collection identified, for example, via a URL and a collaborative document area identified, for example, via a virtual world location identifier, such as Second Life URL (SLURL) for embodiments implemented using Second Life.

The teleport engine 132 can ensure the access permissions of the document management system 110 are properly and consistently checked by the access manager 134 before the user/avatar is transported to the shared collaborative document area 122 by the teleport engine 132. In some embodiments, the user/avatar can request to teleport a collaborative document area 122 corresponding to a particular collection of documents 114 via a single click of a mouse or a virtual repository kiosk in any 3D virtual world.

As one example, a user who is logged into the document management system 110 and who is currently working with a collection of documents 14 from the content repository 112 can choose to transport to the collaborative document area 122 in the 3D virtual world 120 to work with the documents 114 of the collection in the collaborative document area 122. The user can select a “Teleport” button provided in the user interface 118. Upon selection of the button, the teleport engine maps the collection of documents to the collaborative document area 122, verifies that the user has the proper access permission via the access manager 134, and automatically teleports the user's avatar into a shared collaborative document area 122 that uniquely corresponds to collection of documents 114 that the user was working with in document management system 110. In some embodiments, the mapping of documents can occur during the initial set-up of the collaborative document area 122. In these embodiments, the collaborative document area can be updated to reflect updates to the corresponding documents of the content repository.

As another example, user can already be logged into the 3D virtual world 120. Virtual repository kiosks can be located at various locations in the 3D virtual world and can facilitate transportation of the avatar from the current location of the avatar to the collaborative document environment 122. The user can manipulate the avatar so that the avatar walks up to a virtual repository kiosk and provides a collection identifier, such as an SLURL for embodiments which implement the collaborative document area 122 in Second Life, along with a repository login username and password if necessary. After the repository authentication succeeds based at least in part on a verification performed by the access manager 134, the avatar is automatically transported to collaborative document area 122 that uniquely corresponds to the provided collection identifier.

Multiple avatars that share the same collaborative document environment form a collaborative community by working on the same collection of documents at the same time. For example, avatars can collaboratively review documents, tag the documents, search other documents, chat with each other, and the like, in the collaborative document area 122. These collaborations can be spontaneous (where avatars are simply brought together due to coincidentally working with the same collection of documents 114 in the content repository 112 at the same time or can be pre-scheduled/planned by distributing an invitation or meeting request to other users, where the collection identifier can be distributed with the invitation.

The access manager 134 enforces consistent content access policies in the shared collaborative document area 122 by issuing a virtual pass to each user/avatar based on an identity of the user, which can be determined using the user name and password of the user. Likewise, the access manager 134 interacts with the 3D virtual world to ensure the accessibility of documents in the shared collaborative document area 122 is aligned with the security level setting of the document management system 110 and that users are provided a proper virtual pass based on an identity of the user. In some embodiments, the document management system 110 employs sophisticated and fine-grain control mechanisms to guard their content access and the 3D virtual world 120 adopts a simpler, coarse-grained protection approach, based on avatars roles or group membership. The access manager 134 provides a multi-level security mechanism using virtual passes having different access levels so that the integrity of access permissions set on repository collections/contents is not compromised and collaborations in the shared collaborative document area 122 can be allowed.

Before a user's transport request to a shared collaborative document area 122 in the 3D virtual world 120 is granted, the access permissions to the underlying collection of documents 114 in the document management system 110 can be verified. To minimize the communication overhead incurred by this verification with the server in which the document management system 110 is implemented, a multi-level virtual pass schema can be implemented. In some embodiments, the multi-level virtual pass schema can include three levels: a VIP virtual pass representing the highest privilege; a general virtual pass representing a medium level privilege; and a guest virtual pass representing a lowest privilege.

Likewise, the collaborative document area 122 can have an associated security level, which must be met before an avatar can be teleported to the collaborative document area. For example, the collaborative document area 122 can have a maximum security level, an exact security level as repository, and a minimum security level. The security levels can correspond to the virtual passes as well as the underlying access policy of the content repository.

The VIP virtual pass can be issued to a user if the requesting user has full access to the collection of documents to be viewed in the collaborative document area 122. Avatars with VIP virtual passes are granted access and can be teleported to a shared collaborative document area set at any security level. For example, the avatar can be teleported to a collaborative document area having a maximum security level, exact security level, and/or a minimum security level. Once an avatar representing the user is teleported with VIP virtual pass, the user can freely access all documents in the shared collaborative environment 122 without additional verifications with document management system 110.

The general virtual pass can be issued if the requesting user has partial access to the collection of documents to be viewed in a shared collaborative document area. In other words, an avatar with a general pass is restricted from viewing some of the documents in the collection. If the shared collaborative document area is set to maximum security, the avatar is not teleported to the collaborative document environment. If the collaborative document area is set at exact security level as repository, the avatar with a general virtual pass can be granted access to the shared collaborative document area 122, but restricted documents are not accessible to the user, without additional verifications. If the collaborative document area is set at minimum security, the avatar with a general virtual pass can be granted access to the shared collaborative document area 122 and all documents can be accessible to the user without additional verifications.

The guest virtual pass represent the lowest access privilege and is issued if the requesting user/avatar has no access to the current collection at all. This is can be particularly useful for an internal training event, while many attendees might not have an existing account for the collaborative document area 122. The guest virtual pass only teleports a user/avatar to a shared collaborative document area 122 that is set at the “minimum security level”. In some embodiments, the guest virtual pass only grants temporary access to the content in the shared collaborative document area 122 and additional verification can be required based on security policies associated with the underlying content repository 112 before the user can access some or all of the documents in the collaborative document area 122.

The customization engine 136 allows the semantic contexts of a repository collection and user specified preferences to be dynamically reflected in the visual characteristics of the shared collaborative document area 122. The customization engine 136 manages pre-defined 3D scene templates that can be dynamically applied based on the semantic contexts, which the customization engine 136 extracts from repository meta-data properties and/or repository structure of a repository collection, and/or user specified preferences. The customization engine 136 can also manage a knowledge base of known or learned document semantic context and their associated 3D scene template and intelligently suggest or automatically select the relevant 3D scene template for a given document semantic context. Spatial clustering/layout algorithms can be applied by the customization engine 136 based on user preferences and document semantic contexts and the size of the collaborative document area 122 can be automatically adjusted according to a number of documents in the repository collection and/or the number of participating avatars in the collaborative document area 122.

In some embodiments, document collections can be created with one or more intended purposes. For example, some documents can be created for project activities and some documents can be created for a particular meeting or event or training lesson. The intended purposes of the documents can be reflected in the repository meta-data properties, such as a title, summary, description, format, owner/creator, timestamp, and the like. The corresponding collaborative document area 122 can be customized using a 3D scene template according to these intended purposes by the customization engine 134.

A 3D scene template defines a prototypical look-and-feel of a collaborative document area. Some examples of a 3D scene template include a virtual classroom, a virtual project workspace, a virtual conference room, an amphitheatre, and the like. In some embodiments, a scene template can be selected when collaborative document area is created for a particular collection of documents. In some embodiments, a scene template can be automatically, intelligently, and/or dynamically suggested to a user based on semantic contexts of a particular collection of documents determined from the meta-data properties.

As one example, if a user creates a collection of documents for a project workplace, the user can select the 3D scene template for a “virtual project workspace”. As another example, if the user creates a collection for a training event, the user can select the 3D scene template for a “virtual 3D classroom”. In some embodiments, the customization engine 136 can select a default 3D scene template or a 3D scene matching the semantic context of the collection of documents to be used when the user does not make a selection.

Once the 3D scene template is determined, the user can be prompted by the customization engine 136 to choose spatial layout/clustering preferences for the documents in the collection. For example, when a default 3D scene is selected, the user can further specify a spatial layout scheme for constituent content stations according to meta-data properties of the documents, such as title, summary, description, format, owner/creator, timestamp, and the like. The documents can be placed in the collaborative document area in different clustering fashions based on the semantic similarity of one or more of their meta-data properties.

After the 3D scene template and layout/clustering scheme are specified, the size of the collaborative document area 122 can be automatically adjusted according to the number of documents in the collection when the collaborative document area 122 is instantiated. The size of the 3D scene can be enlarged to accommodate the number of participating avatars in the collaborative document area. For example, if the number of avatars in the collaborative document area 122 exceeds a specified threshold value, the 3D scene can be enlarged.

The interaction management system 140 tracks, monitors, and captures document interactions occurring around content of documents in the collaborative document area 122. The interaction management system 140 enhances the shared collaborative document area 122 using multi-modal document interactions to facilitate compelling social experiences amongst a community of users. The document interactions can be associated with documents using a referencing scheme to facilitate mutual referencing. The interaction management system 140 extends the meta-data structure of the content repository 112 with semantic-rich interaction contexts of the document interactions so that the persistent document interactions enable experiences-mediated content search and navigation for users of the content repository 112. For example, the interaction management system 140 can allow users to retrieve documents that attracted the most document interactions, that received document interactions from a specific user or users, that negative or positive reactions, and the like. One exemplary interaction management system is described in more detail in copending U.S. application Ser. No. ______ (Attorney docket #20082025/1846-37), entitled “Managing Document Interactions In Collaborative Document Environments of Virtual Worlds” and filed on even date herewith, the disclosure of which is incorporated herein by reference in its entirety.

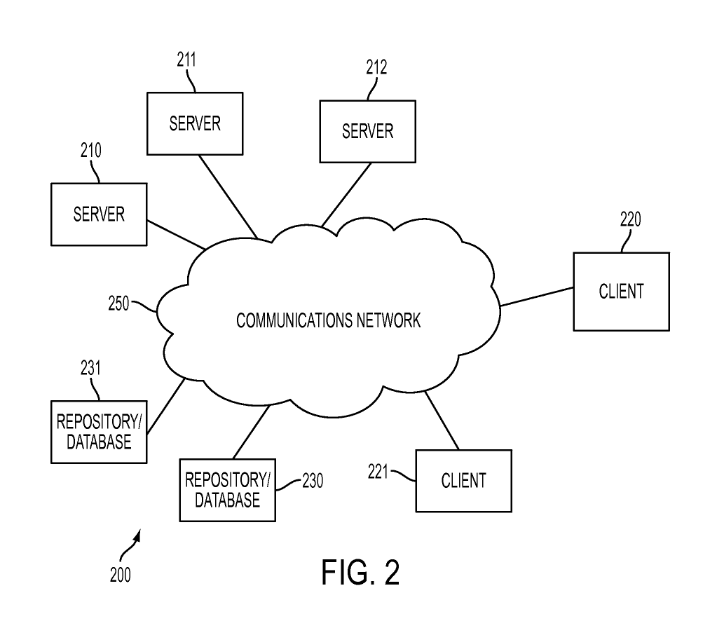

FIG. 2 is an exemplary computing system 200 configured to implement embodiments of the environment 100. The computing system 200 includes one or more servers 210-213 coupled to clients 220-223, via a communication network 250, which can be any network over which information can be transmitted between devices communicatively coupled to the network. For example, the communication network 250 can be the Internet, Intranet, virtual private network (VPN), wide area network (WAN), local area network (LAN), and the like. The computing system 200 can include repositories or database devices 230-233 (hereinafter “database devices 230-233”), which can be coupled to the servers 210-213, as well as to clients 220-223, via the communications network 250. The servers 210-213, clients 220-223, and database devices 230-233 can be implemented using computing devices.

The servers 210-213, clients 220-223, and/or repository devices 230-233 can store information, such as documents, user names, passwords, shared collaborative document areas, 3D scene templates, security levels, virtual passes, meta-date properties, document interactions, and the like. In some embodiments, the interfacing unit 130 and/or the interaction management system 140 can be distributed among the servers 210/220, clients 230/240, and/or database devices 230-233 such that one or more components of the interfacing unit 130 and/or interaction management system 140, or portions thereof, can be implemented by a different device (e.g. clients, servers, databases) in the communication network 250.

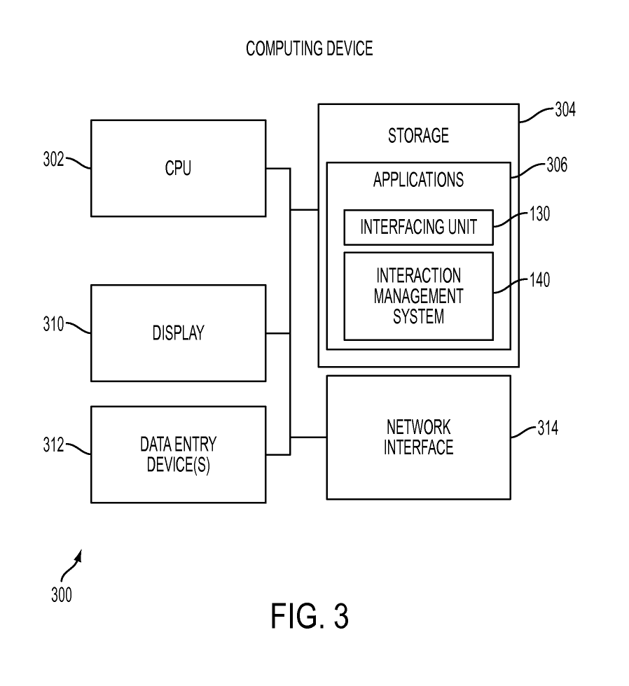

FIG. 3 is a block diagram of an exemplary computing device 300 configured to implement embodiments of the interfacing unit 130 and/or the interaction management system 140. The computing device 300 can be a mainframe, personal computer (PC), laptop computer, workstation, handheld device, such as a portable digital assistant (PDA), and the like. In the illustrated embodiment, the computing device 300 includes a central processing unit (CPU) 302 and can include storage 304. The computing device 300 can further include a display device 310 and data entry device(s) 312, such as a keyboard, touch screen, and/or mouse. The display device 310 enables the computing device 300 to communicate with a user through a visual display.

The storage 304 stores data and instructions and can be implemented using technologies, such as a floppy drive, hard drive, tape drive, Flash drive, optical drive, read only memory (ROM), random access memory (RAM), and the like. Applications 306, such as the interfacing unit 130 and/or the interaction management system 140, or portions thereof, can be resident in the storage 304. The applications 306 can include instructions for implementing embodiments of the interfacing unit 130 and/or the interaction management system 140. The storage 304 can be local or remote to the computing device 300. The computing device 300 includes a network interface 314 for communicating with a network, such as the communication network 350 of FIG. 2.

The CPU 302 operates to run the applications 306 in storage 304 by executing instructions therein and storing data resulting from the executed instructions, which may be presented to a user via the display 310 or by other mechanisms known to those skilled in the art, such a print out from a printer.

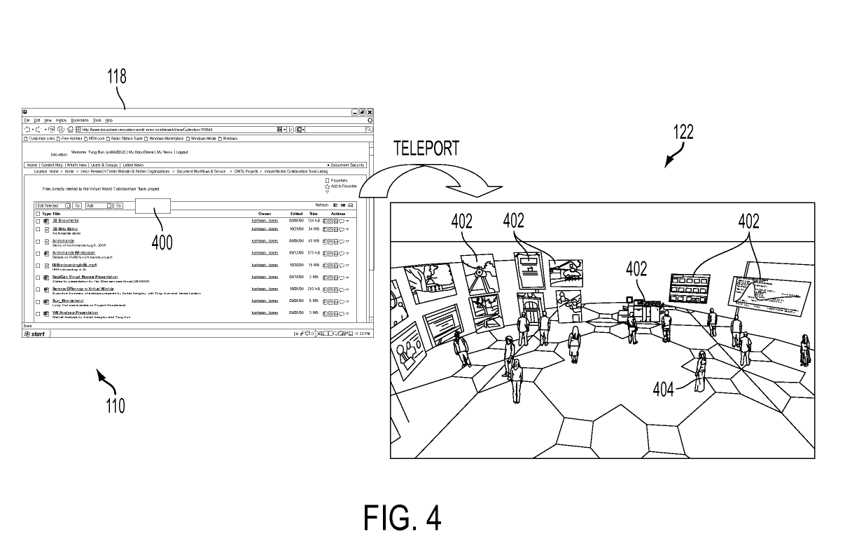

FIG. 4 illustrates an exemplary implementation of teleportation from the document management system 110 to the collaborative document area 122 of the 3D virtual world. The user can be logged in to the document management system and can be working in a repository collection using the GUI 118. The GUI 118 can include a selectable “Teleport” button 400, which when selected, causes the teleport engine to map documents 402 of the repository collection being viewed to the collaborative document area 122 uniquely corresponding to the current repository collection being viewed and causes an avatar 404 representing the user to be teleported to the collaborative document area 122 as well. In some embodiments, the documents can be teleported to the collaborative document area when the collaborative document area is created and the collaborative document area can be updated when there are changes to the content repository.

Prior to teleporting the avatar to the collaborative document area the access manager 134 determines the proper security level of the user. The access manager 134 associates a virtual pass with the user based on the determined security level. Also, prior to teleporting the avatar to the collaborative document area 122, the customization engine 136 formats the collaborative document area 122 to automatically ensure the proper layout of the documents and the proper look and feel of the environment. In some embodiments, customization of the collaborative document area can be specified when the collaborative document area is created and the collaborative document area can be updated based on changes to the content repository and/or user preferences.

Multiple avatars share the collaborative document area 122. When multiple avatars share the same collaborative document area 122, a collaborative community is formed in which user represented by the avatars are working on the same collection of documents at the same time. For example, in the collaborative document area 122, avatars can collaboratively review documents, tag the content, search other documents, chat with each other, and the like. These collaborations can be spontaneous, for example, where users are coincidentally working in the same repository collection at the same time and/or can be pre-scheduled/planned, for example, where users are invited to view a collection of documents in the collaborative document area 122 at a specified time.

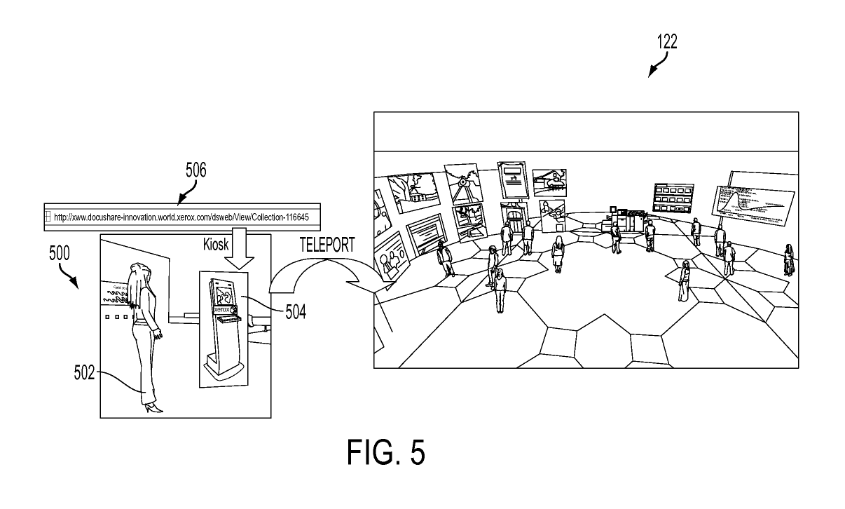

FIG. 5 illustrates an exemplary implementation of teleporting from a first location 500 in the 3D virtual world to the collaborative document environment 122. When the avatar representing the user is currently in the 3D virtual world 120, an avatar 502 representing the user can be controlled to approach a virtual repository kiosk 504. Once the avatar 502 reaches the virtual repository kiosk 504, the user can enter a repository identifier 506, such as a collection URL, into the virtual repository kiosk 504 along with a repository login username and password. After the repository authentication implemented using the access manager succeeds, the avatar 502 is automatically transported to collaborative document area 122 that uniquely corresponds to the collection identifier that was provided, which is formatted and laid out automatically by the customization engine 136.

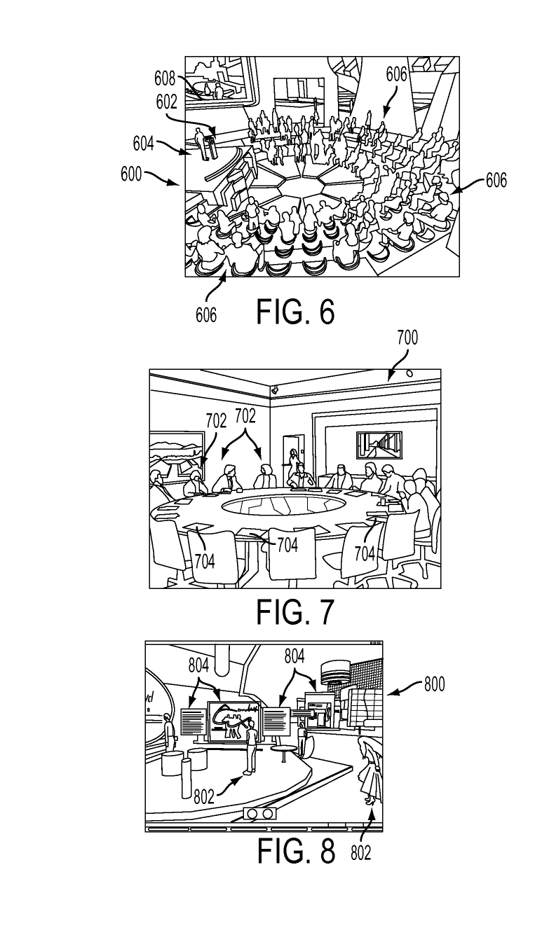

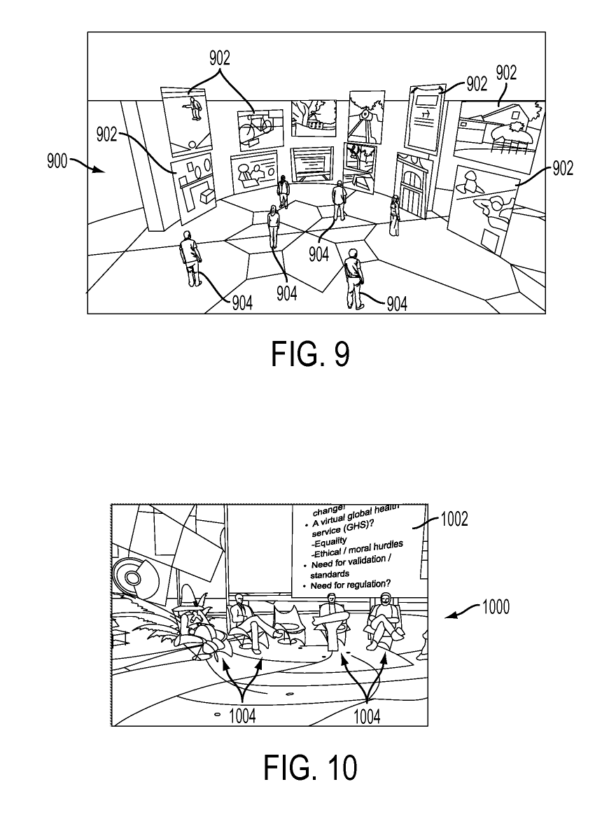

FIGS. 6-10 illustrate various implementations of the collaborative document environment 122, which can be generated using the customization engine 136. FIG. 6 illustrates an exemplary class room scene 600 that can be generated. The scene 600 can include a presentation podium 602 at which an avatar 604 representing a user who is presenting can stand. Other avatars 606 can be seated in chairs in front of the avatar that is presenting. A document 608 can be displayed behind the avatar that is presenting so that the other avatars can view the document 608 as the avatar presents. FIG. 7 illustrates an exemplary conference room scene 700, in which users through their avatars 702 can perform a collaborative review of documents 704 and can have various interactions related to the documents 704. FIG. 8 illustrates an exemplary demonstration or exhibit room scene 800 where users represented as avatars 802 can move between documents 804 and can interact with other avatars viewing the documents 804. The exhibit room 800 can represent, for example, a virtual science fair where students can present their projects to other users in the collaborative document area. FIG. 9 illustrates an exemplary gallery style scene 900, which can include documents 902 distributed throughout the scene. User represented as avatars 904 can move through the gallery-style scene 900 to review the documents 902 and can interact with one other, for example, by commenting on the documents. FIG. 10 illustrates an exemplary virtual project space 1000 in which at least one document 1002 can be displayed and in which users represented as avatars 1004 can review the document 1002 in a collaborative manner.

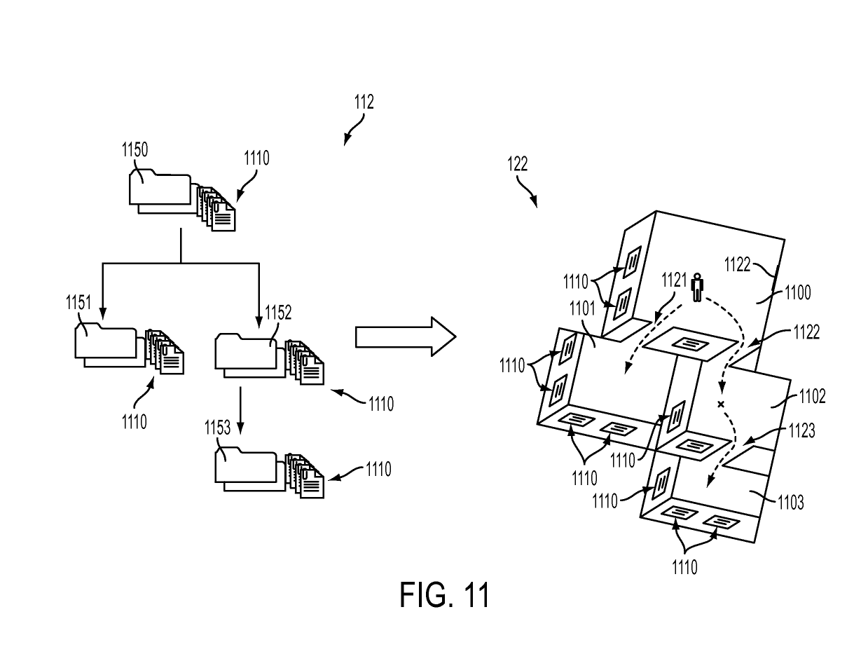

FIG. 11 illustrates an exemplary navigation in the collaborative document environment. The documents in the content repository can be stored in a hierarchical manner, for example, using a folder and subfolder system. The hierarchical structure of the content repository can be reflected in the collaborative document area. The collaborative document area 122 can include a number of rooms that equals a number of folders associated with a collection of documents. If a subfolder exists, another room can be connected to the room using a doorway to allow the avatar to enter the other room to view the documents associated with the subfolder.

In the present example, the collaborative document area 122 has rooms 1100-1103 corresponding to folders 1150-1153 in the content repository 112. The folders 1151 and 1152 are subfolders of the folder 1150, and the folder 1153 is a subfolder of the folder 1152. The folders 1150-1153 represent an exemplary hierarchy of folders in the document management system. The folders can include documents 1110, which can be mapped to the rooms 1100-1103 can by the teleporting engine. The documents 1110 included in room 1100 correspond to the documents 1110 included in the folder 1150. The documents 1110 included in the room 1101 correspond to the documents 1110 included in folder 1151. The documents 1110 included in room 1102 correspond to the documents 1110 included in the folder 1152. The documents 1110 included in the room 1103 correspond to the documents 1110 included in folder 1153. The rooms 1101 and 1102 can be connected to the room 1100 via doors 1121 and 1122, and the room 1103 can be connected to the room 1102 via doors 1123.

While in room 1100 the avatar can view documents contained in the folder 1150. If the user wishes to view documents in the subfolder 1151, the avatar can be moved through the door 1121 into the room 1101. Likewise, if the user wishes to view the documents included in subfolder 1152, the user can move the avatar through the door 1122. If the user wishes to descend further into the hierarchical structure of the content repository, the user can move the avatar from room 1102 to room 1103 via door 1123 so that the user can view documents contained in the folder 1153.

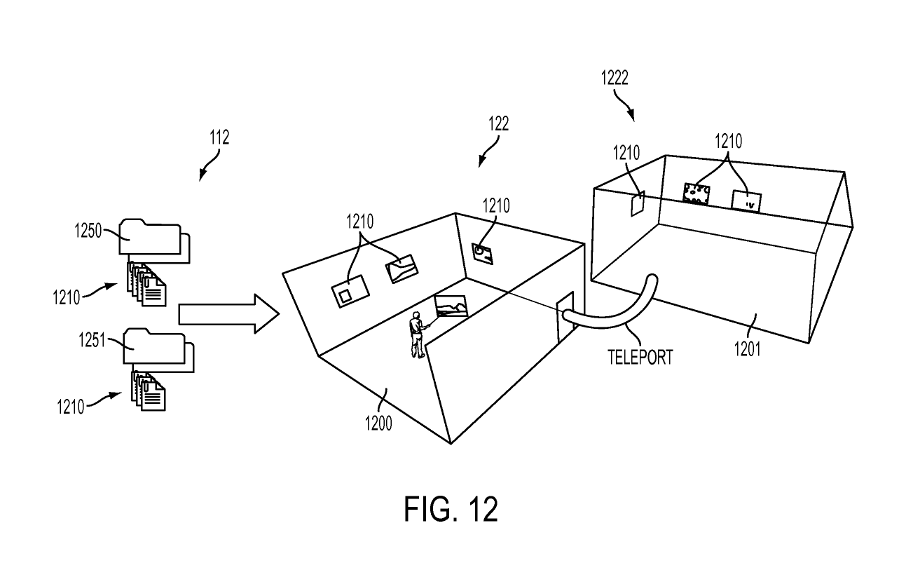

FIG. 12 illustrates another example of navigation in the collaborative document environment. A collaborative document area can be generated for each layer in the hierarchal structure of a collection of documents in the content repository. The collaborative document areas can be tele-connected based on the hierarchy of the documents in the content repository so that avatars wishing to explore other layers of the hierarchy can be teleported to the other collaborative document areas via a teleporting door.

In the present example, collaborative document areas 1200 has a room 1202 corresponding to folder 1250 in the content repository 112 and collaborative document area 1210 has a room 1212 corresponding to folder 1210. The folder 1251 is a subfolder of the folder 1250. The folders 1250-1251 represent an exemplary hierarchy of folders in the document management system. The folders can include documents 1210, which can be mapped to the rooms 1200-1201 can by the teleporting engine. The documents 1210 included in room 1200 correspond to the documents 1210 included in the folder 1250. The documents 1210 included in the room 1201 correspond to the documents 1210 included in folder 1251. To navigate the hierarchical structure of the content repository from the folder 1250 to the folder 1251 in the virtual 3D world, the user can move the avatar through a door 1220, which results in a teleportation of the avatar from the room 1200 to the room 1201.

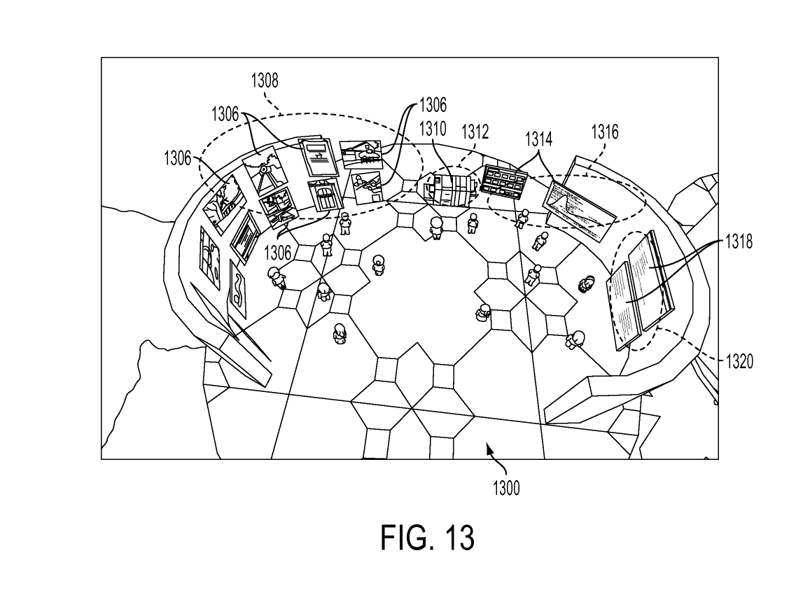

FIG. 13 illustrates an exemplary organization of documents in the collaborative document environment 122 based on one or more meta-data properties associated with the documents. In the present example, the customization engine organized documents in the scene 1300 based on file types. For example, documents 1306 having an image format, such as JPEG, TIFF, and the like, are clustered together at a first location 1308, documents 1310 having a 3D modeling file types are clustered at a second location 1312, document 1314 having a presentation file type, such as a PowerPoint document, are clustered at a third location 1316, and documents 1318 having a web-based file type, such as HTML documents, are clustered at a fourth location 1320. The customization engine can automatically specify the spatial layout/clustering of documents based on predefined or default preferences or can specify the spatial layout/clustering of document in response to user selections.

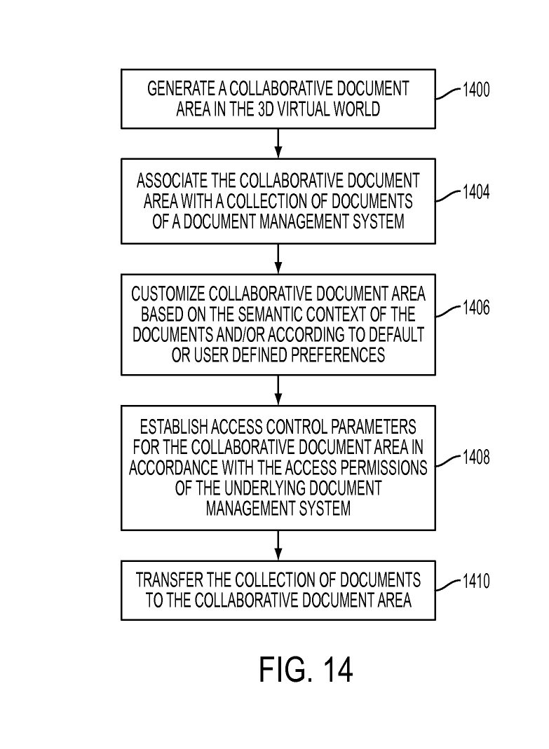

FIG. 14 is a flowchart illustrating an exemplary implementation of one embodiment of the collaborative document environment. A collaborative document area can be generated in the 3D virtual world, the location of which can be specified as a unique virtual world identifier (e.g., SLURL) (1400). The collaborative document area is associated with a collection of documents having a specified location in a document management system (1404). The collaborative document area is customized based on the semantic context of the documents and/or according to default or user defined preferences (1406) and access control parameters are established for the collaborative document area in accordance with the access permissions of the underlying document management system (1408). The collection of documents is teleported to the collaborative document area so that users can view the documents in the collaborative document area (1410).

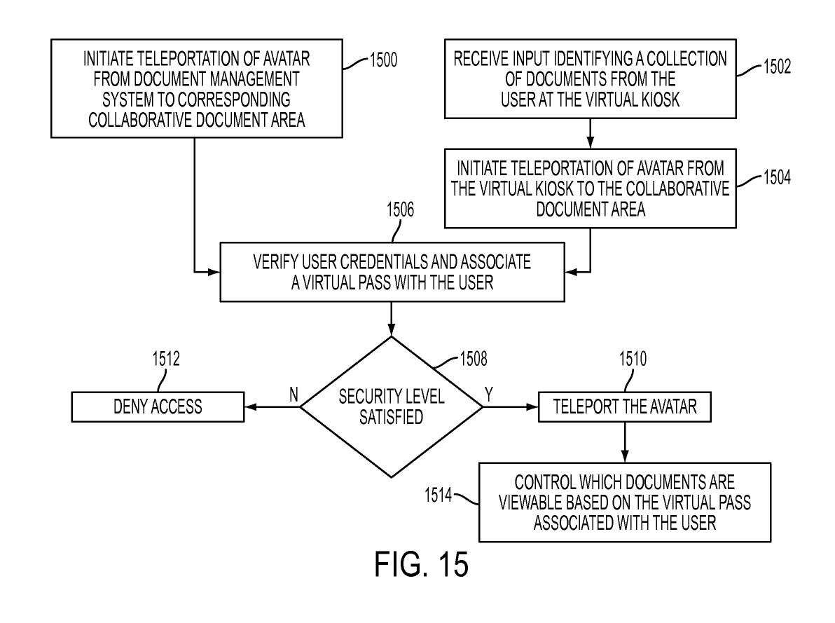

FIG. 15 is a flowchart illustrating an exemplary implementation of teleporting users to the collaborative document area and maintaining access control for documents in the collaborative document area. A user that is logged in to the document management system and reviewing a collection of documents can initiate teleportation of an avatar representing the user to the corresponding collaborative document area by the teleport engine in response to selecting a teleport button in a user interface of the document management system (1500). Alternatively, users that are logged in to the 3D virtual world can visit a virtual repository kiosk. The virtual repository kiosk can receive input from the user including, for example, a user name, password, and location identifier associated with the collaborative document area or the collection of documents in the document management system (1502). The teleport engine initiates teleportation of the avatar from the virtual kiosk to the collaborative document area (1504).

In either case, the user's credentials are verified by the access manager, which associates a virtual pass with the user (1506). Upon satisfaction of the security level assigned to the collaborative document area (1508), the avatar representing the user is teleported to the collaborative document area (15 10). Otherwise, the user is denied access (1512). While in the collaborative document area, the virtual pass associated with the user controls which documents the user can view and which documents are restricted from being viewed by the user (1514). Other users can enter the collaborative document area using the interface in the document management system to interact with the documents and other users in the collaborative document area.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

1. A method for reviewing a collection of documents stored in a repository of a document management system, the method comprising:
associating a shared collaborative document area in a virtual world with a corresponding collection of documents in a document management system; and
customizing the shared collaborative document area based on a semantic context of the documents in the collection of documents.

2. The method of claim 1, wherein customizing the shared collaborative document area comprises determining semantic context in the collection of documents based on one or more meta-data properties associated with the documents.

3. The method of claim 2, wherein the one or more meta-data properties include at least one of a title, document creator, document date of creation, document summary, document description, and document file type.

4. The method of claim 1, wherein customizing the shared collaborative document area comprises defining a spatial layout of the documents based on semantic context of the documents.

5. The method of claim 1, wherein the customizing the shared collaborative environment comprises identifying a 3D scene template associated with the semantic context to be depicted.

6. The method of claim 1, further comprising controlling access to the collaborative document area based on a virtual pass associated with the user.

7. The method of claim 6, wherein controlling access comprises:
determining whether a security level associated with the collaborative document area is satisfied by the virtual pass; and
granting access to the user in response to a determination that the security level is satisfied by the virtual pass.

8. The method of claim 7, further comprising:
controlling a visibility of the documents in the collaborative document area to prevent the user from viewing at least some of the documents in the shared collaborative environment based on the virtual pass associated with the user.

9. The method of claim 1, further comprising:
transporting an avatar representing a user to the shared collaborative document area in response to receipt of at least one of a collection identifier associated with the unique collection of documents and a virtual identifier associated with the shared collaborative document area.

10. A computer readable medium storing instructions executable by a computing system including at least one computing device, wherein execution of the instructions implements a method for reviewing a collection of documents stored in a repository of a document management system comprising:
associating a shared collaborative document area in a virtual world with a corresponding collection of documents in a document management system; and
customizing the shared collaborative document area based on a semantic context of the documents in the collection of documents.

11. The medium of claim 10, wherein customizing the shared collaborative document area comprises determining semantic context in the collection of documents based on one or more meta-data properties associated with the documents.

12. The medium of claim 10, wherein customizing the shared collaborative document area comprises defining a spatial layout of the documents based on semantic context of the documents.

13. The medium of claim 10, wherein the customizing the shared collaborative environment comprises identifying a 3D scene template associated with the semantic context to be depicted.

14. The medium of claim 10, further comprising controlling access to the collaborative document area based on a virtual pass associated with the user.

15. The medium of claim 14, wherein controlling access comprises:
determining whether a security level associated with the collaborative document area is satisfied by the virtual pass; and
granting access to the user in response to a determination that the security level is satisfied by the virtual pass.

16. A system for reviewing a collection of documents stored in a repository of a document management system comprising:
a computer system having one or more computing devices, the computing system configured to associate a shared collaborative document area in a virtual world with a corresponding collection of documents in a document management system and customize the shared collaborative document area based on a semantic context of the documents in the collection of documents.

17. The system of claim 16, wherein the computer system is configured to customize the shared collaborative document area by defining a spatial layout of the documents based on semantic context of the documents.

18. The system of claim 16, wherein the computer system is configured to customize the shared collaborative environment by identifying a 3D scene template associated with the semantic context to be depicted.

19. The system of claim 16, wherein the computer system is configured to control access to the collaborative document area based on a virtual pass associated with the user.

20. The system of claim 19, wherein the computer system is configured to control access by determining whether a security level associated with the collaborative document area is satisfied by the virtual pass and granting access to the user in response to a determination that the security level is satisfied by the virtual pass.
